(19) United States
(12) Patent Application Publication
(10) Pub. No.: US 2025/0205765 A1
(43) Pub. Date: Jun. 26, 2025

(54) METHOD AND DEVICE FOR PRODUCING TUBES, WIRES, PROFILES AND SIMILAR ELONGATE MATERIAL BY MEANS OF A DRAWING DEVICE

(71) Applicant: QASS GmbH, Wetter (DE)

(72) Inventor: Ulrich Seuthe, Wetter (DE)

(21) Appl. No.: 18/850,416

(22) PCT Filed: Mar. 27, 2023
(86) PCT No.: PCT/EP2023/057866

§ 371 Date: Sep. 24, 2024

(30) Foreign Application Priority Data
Mar. 25, 2022 (DE) 102022001052.6

(51) Int. Cl. B21C 1/12; B21C 51/00; G01H 1/14

(52) U.S. Cl. CPC B21C 1/12; B21C 51/00; G01H 1/14

(57) ABSTRACT

The invention relates to a method for producing tubes, wires, profiles and similar elongate material by means of a drawing device (1), in which, during the drawing process, vibration emissions at a material strand and/or at the drawing device (1) are detected and evaluated in order to identify faults such as grooving and chatter marks, the vibration emissions being subjected continuously to a spectral analysis in such a way that the presence or absence of emissions that are increasing and decreasing over time and/or of pulse-like emissions is identified, and the drawing speed is altered in response thereto.

### FIELD OF THE INVENTION

The invention relates to a method and a device for producing tubes, wires, profiles and similar long material according to the preamble of claims 1 and 6.

### BACKGROUND TO THE INVENTION

One manufacturing process for the production of pipes, wires, profiles and similar long materials is drawing. In this form of combined tensile and compressive forming, a material strand, usually made of metal, is pulled through a die. As a result, the material strand takes on the shape of the opening of the die on the outside and generally becomes longer and thinner. If the material strand is a hollow body such as a tube, a mandrel can co-operate with the die to form a gap, in particular an annular gap.

Depending on the material, tool, wear, lubricant and process parameters, so-called chattering can occur during the drawing process, in which resonant vibrations occur and lead to damage in the form of chatter marks on the material strand or to the material strand being torn off.

To detect and avoid chattering during tube drawing, it is known from EP 0 780 171 A1, for example, to detect vibrations of the tube-mandrel-drawing machine drawing system by means of structure-borne sound sensors and to monitor the vibration amplitude for exceeding a limit value or by means of a fuzzy logic system in order to reduce the drawing speed to avoid chattering.

The disadvantage here is that high amplitudes that are not caused by chattering can lead to a misguided reduction in the drawing speed. In addition, chattering can only be reliably recognised when it is already occurring As a result, only a sub-optimal material throughput can be achieved with the known method.

Other defects in pipe drawing, in particular drawing grooves, cannot be recognised with the known method.

The same problem arises when pulling through wires, profiles and the like.

### SUMMARY OF THE INVENTION

Based on this, the object of the invention is to create a method and a device for producing tubes, wires, profiles and similar long material according to the preamble of claims 1 and 6, with which defects such as chattering and drawing grooves can be reliably excluded while ensuring a high material throughput.

This object is achieved in accordance with the features of claims 1 and 6.

Accordingly, a method is created for drawing tubes, wires, profiles and similar material strands by means of a drawing device, in which method vibration emissions are detected and analysed during the drawing process on the material strand and/or on the drawing device in order to detect defects such as drawing grooves and chatter marks, wherein the vibration emissions are continuously subjected to a spectral analysis in such a way that the occurrence or absence of, in particular, frequency-selective emissions which rise and fall over time and/or, in particular, frequency-selective, pulse-like emissions is recognised, and that the drawing speed is changed in response thereto.

Spectral analysis can be used to recognise signal patterns that indicate the onset of chattering several hundred milliseconds in advance. Chattering can be prevented more reliably compared to an analysis based on the vibration amplitude, as is known from the prior art. The same applies to broadband, pulse-like emissions, which are typical for drawing grooves. These can also be recognised by means of the spectral analysis according to the invention before they become too energy-intensive and leave behind traces on the material strand.

It is expedient to reduce the drawing speed if such emissions are detected by spectral analysis and to increase it if they are absent. Adaptive control of the drawing speed based on this ensures that work is always carried out at the maximum possible drawing speed.

The evaluation can be carried out on the basis of the multi-dimensional pattern recognition developed by the applicant, as is known, for example, from EP 2 359 106 A2, which is hereby incorporated in its entirety by reference.

It is particularly advantageous to divide the vibration emissions into frequency ranges of low and high emission and to perform the detection in the low emission range. This can be based on an amplitude threshold value in the spectrum or the vibration intensity, e.g. as a percentage of the maximum over time. The amplitude threshold value for a low emission can be, for example 1%, 2%, 3%, 5%, 7%, 10%, 15%, 20%, 25%, 30%, 35% and the considered time course 0.1 s, 0.2 s, 0.3 s, 0.4 s, 0.5 s, 1 s, 2 s, 3 s, 5 s, 7 s, 10 s, 15 s, 20 s, 25 s, 30 s, 50 s, 1 min, 2 min, 3 min, 5 min, 10 min or variably coupled with the variation of the vibration intensity in such a way that the threshold value increases with increasing variation of the vibration emissions and the threshold value decreases with decreasing variation of the vibration emissions.

The invention also provides a drawing device for drawing tubes, wires, profiles and similar material strands in accordance with the method according to the invention, with a sensor for detecting vibrations which occur on the material strand and/or on the drawing device during the drawing process, and an evaluation device coupled to the sensor for evaluating the detected vibrations for the purpose of recognising defects such as drawing grooves and chatter marks, wherein the evaluation device is designed to continuously subject vibration emissions to a spectral analysis in such a way that the occurrence or absence over time of rising and falling emissions and/or pulse-like emissions is detected, and is designed for open-loop or closed-loop control of the drawing speed in response to the detection.

Further features and embodiments of the invention can be found in the following description with reference to the accompanying drawings.

### FIGURE DESCRIPTION

FIG. 1A illustrates a tube drawing device in longitudinal section.

FIG. 1B is a perspective view of a portion of a tube drawing device.

FIG. 1C illustrates a tube drawing device with a fixed mandrel in longitudinal section.

FIG. 1D illustrates a tube drawing device with a travelling rod in longitudinal section.

FIG. 1E illustrates a tube drawing device with flying mandrel in longitudinal section.

FIG. 2A illustrates the vibration spectrum of an almost complete pipe drawing process.

FIG. 2B shows a detail of FIG. 2A.

FIG. 2C illustrates the vibration spectrum in normal, chatter-free operation.

FIG. 2D is a detail of FIG. 2A immediately before the start of chattering.

FIG. 2E shows individual vibration patterns from FIG. 2D.

FIG. 2F shows a vibration from FIG. 2E.

FIG. 3 illustrates the spectrum with adaptive control of the drawing speed.

FIG. 4 illustrates accumulated chatter pulses.

### DESCRIPTION OF THE EMBODIMENTS

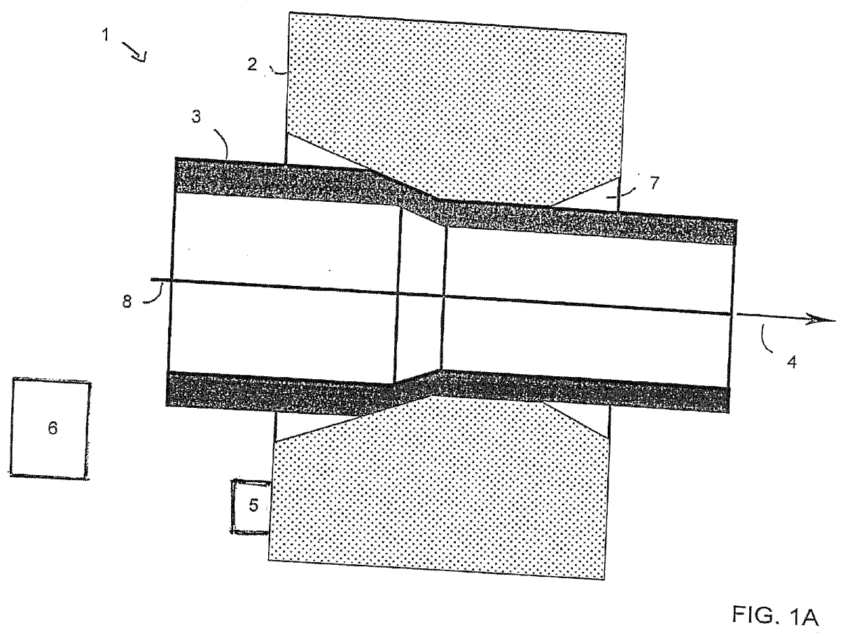

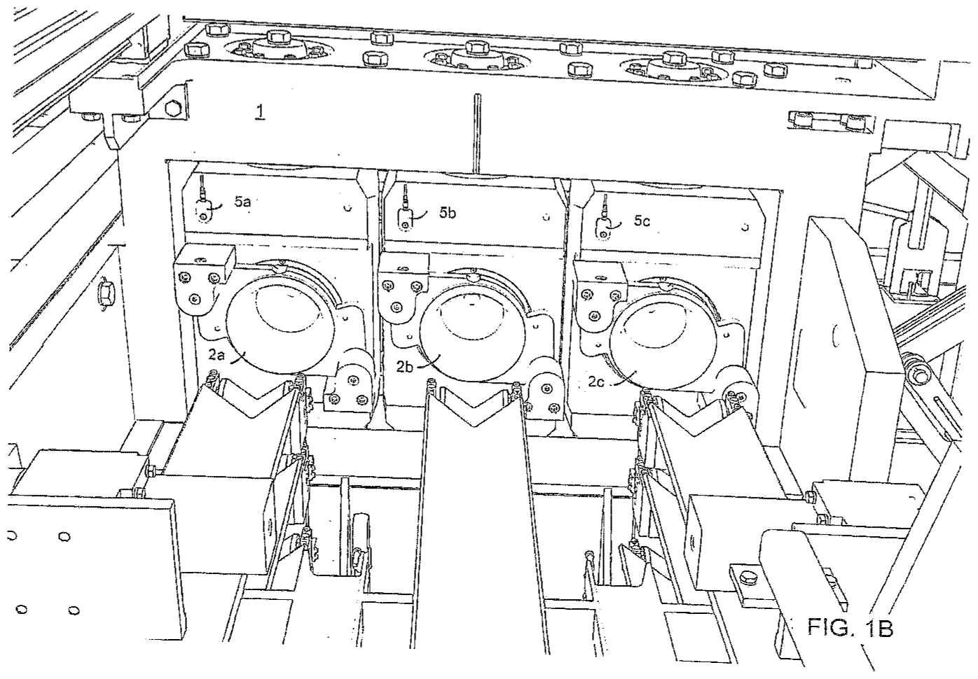

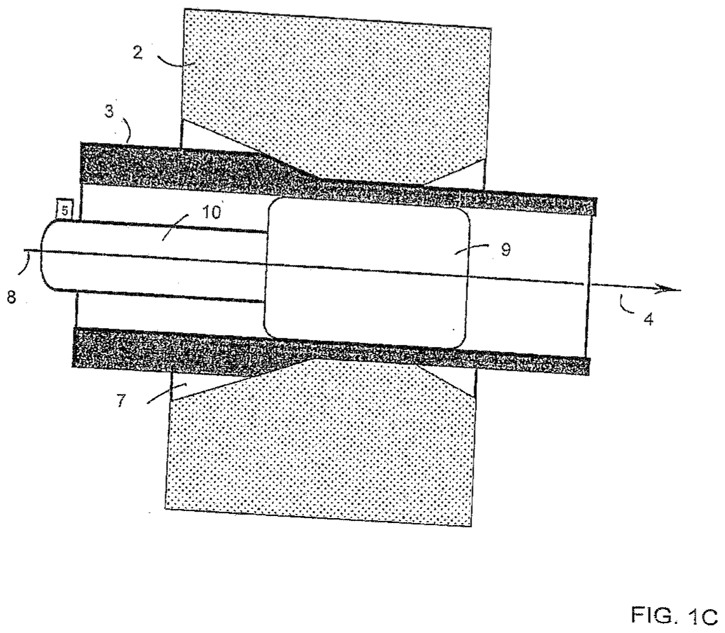

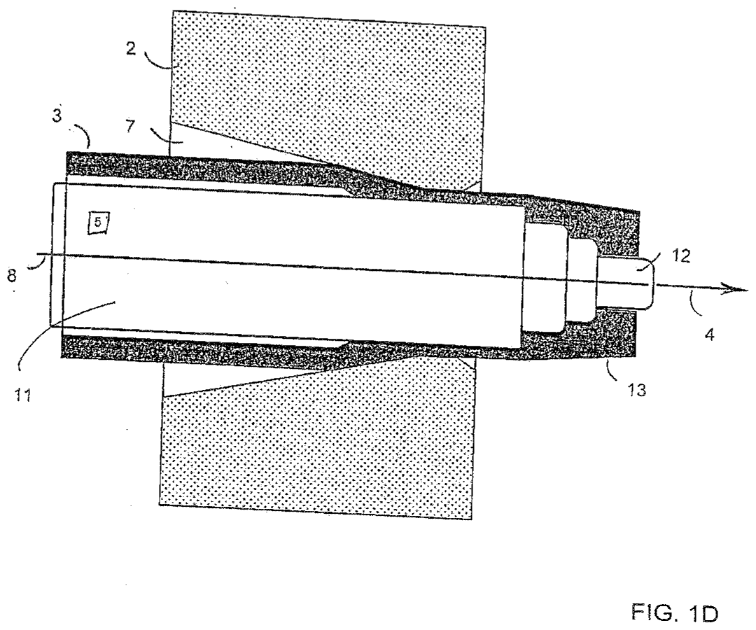

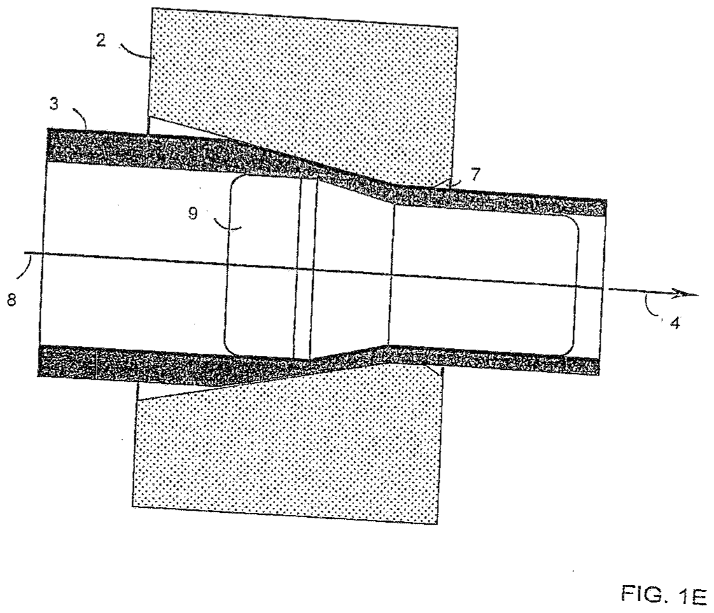

The drawing device 1 schematically illustrated in FIG. 1A for drawing tubes, for example, comprises a die 2, through which a tube 3 is drawn in the direction of the arrow 4 in order to reduce the outer diameter and tube thickness, and a sensor 5 for detecting vibration emissions, which is arranged here as an example on the die 2 and coupled to an evaluation device 6, e.g. a computer.

The exemplary die 2 has an aperture 7, which in this case is rotationally symmetrical about the centre axis 8 and tapers from an input-side diameter to an effective diameter. The tube 3 undergoes combined and tensile compressive forming to a desired target diameter as it is drawn through the die 2. When dimensioning the effective diameter, it must be taken into account that the tube 3 may spring back on the outlet side of the taper depending on the degree of springback of the material and may therefore become larger than the effective diameter of the die 2. It is expedient for the diameter of the die 2 to expand again slightly on the outlet side.

The drawing device 1 can have several dies 2, see FIG. 1B. Three dies 2a, 2b, 2c, through which tubes can be drawn simultaneously, are illustrated by way of example. A sensor 5a, illustrated here with a cable stub, is assigned to at least one drawing hole 2a. It is expedient to assign a sensor 5a, 5b, 5c to each drawing hole 2a, 2b, 2c, respectively. Preferably, the sensor 5 is coupled to the die 2 or an element fixedly connected thereto.

The tube 3 can also be supported from the inside by an inner tool, which is suitable for coupling the sensor 5 in addition to the die 2 or instead of the die 2. For example, a mandrel 9 can be provided, which is attached to a mandrel rod 10: see FIG. 1C. During the drawing process, the tube 2 is then drawn through an annular gap formed between the die 2 and the mandrel 9 and takes on the dimension of the die 2 in the outer diameter and the dimension of the mandrel 9 in the inner diameter, plus any springback. In this case, the sensor 5 can be coupled to the mandrel rod 10. The same applies when using a travelling rod 11; see FIG. 1D, which is inserted through the tube instead of the mandrel 7 and is detected by a drawing tool via a cylindrical head attachment 12, which extends through the tapered end 13 of the tube 2. The sensor 5 can be coupled to the travelling rod 11.

If, on the other hand, a floating inner tool is provided, e.g. the floating mandrel 9 in FIG. 1E, this is not suitable for coupling the sensor 5. The sensor 5 is then coupled to the die 2 or an element fixedly connected thereto.

Although FIG. 1 illustrates a wire drawing device for the purpose of illustration, according to the invention the drawing device 1 is suitable for drawing tubes, wire, profiles or other strands of material and may have further components for this purpose, such as an inner tool or a pulling device.

The sensor 2 is preferably a structure-borne sound sensor, e.g. a piezo sensor. Other types of sensors can also be used as long as they can detect vibrations in the frequency range of interest.

The sensor 2 is coupled to the die 2, the tube 3, an inner tool or a part that is vibration-coupled to the die 2, the tube 3 and/or the inner tool in such a way that it can detect vibrations of the tube 3 and/or the die 2 and/or the inner tool. In the simplest case, the sensor is screwed in place.

During the drawing process, vibrations occur on the tube 3 and on the drawing device 1, in particular on the outer tool drawing die 2 or on the inner tool, which are picked up by the sensor 5. For this purpose, the sensor 5 is designed in such a way that it can detect frequencies between a lower limit value and an upper limit value. Ideally, the lower limit value is 0 and the upper limit value x, so that the entire spectrum of interest can be picked up. In practice, an upper limit value of at least 50 MHz, preferably at least 100 MHz, is expedient. Frequencies below 90 kHz or 40 kHz are preferably attenuated or cut off in practice, as they do not contain any usable information, so that a corresponding lower limit value is expedient, but can also be 50 kHz, 100 kHz, 500 kHz or 1 MHz.

The actual frequency range of the sensor 5 should be selected based on the material to be drawn and the drawing speed. The frequency range between approximately 180 kHz and 400 kHz has proven to be particularly informative.

According to the invention, the vibrations detected by the sensor 5 during the processing of the workpiece 3 are subjected to a spectral analysis, e.g. in the form of a frequency-time analysis. For this purpose, the recorded vibration spectrum can be temporarily stored in the evaluation device 6, which is preferably a computer with a corresponding interface and suitable storage media.

In the evaluation device 6, the frequency-time analysis can be carried out in such a way that the vibration spectrum is displayed graphically and/or analysed numerically during or after acquisition.

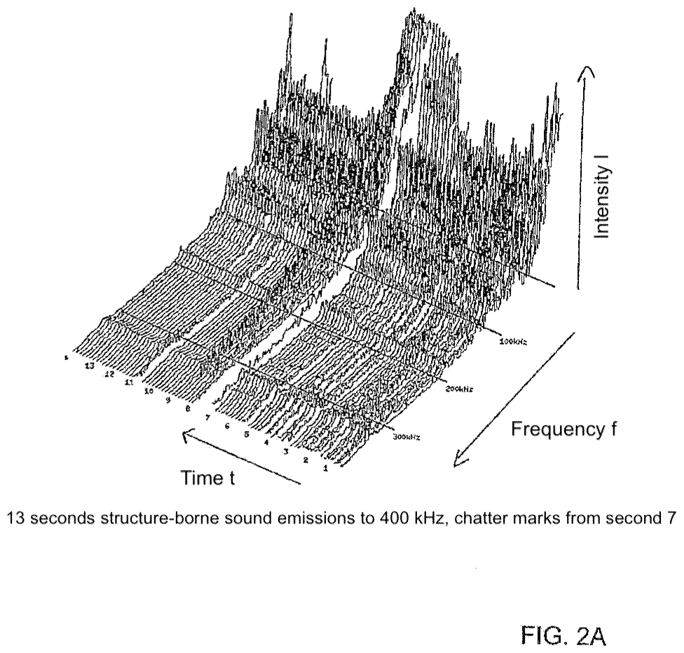

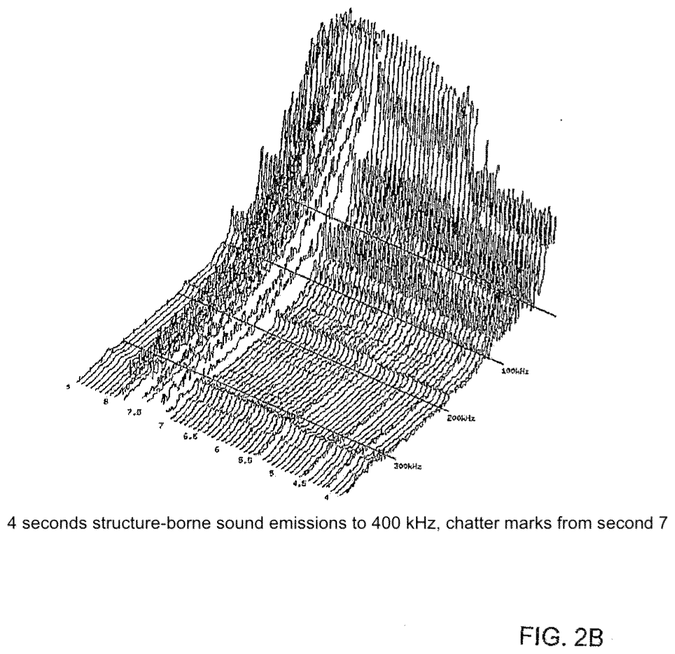

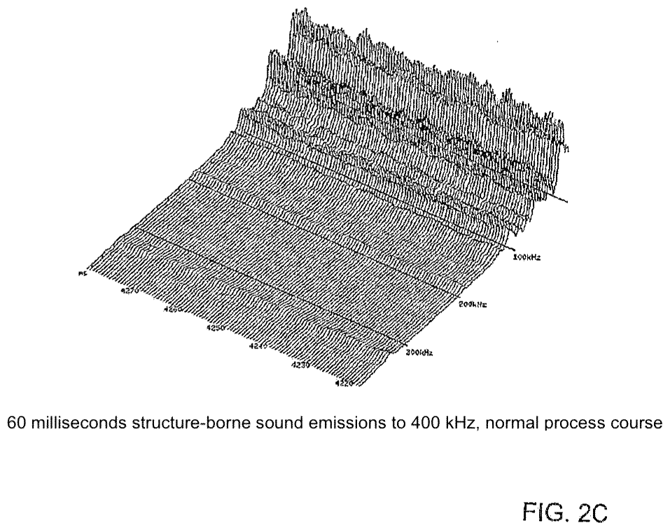

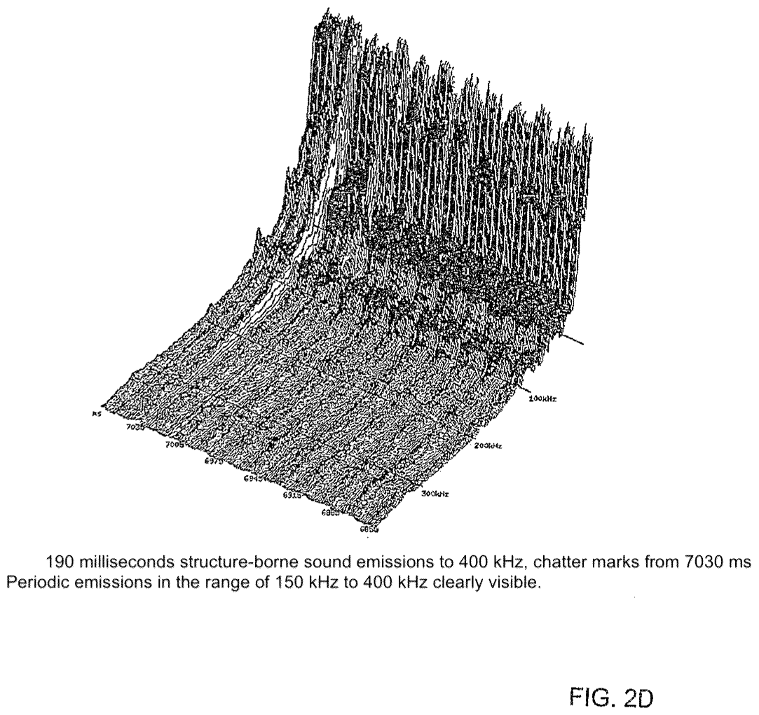

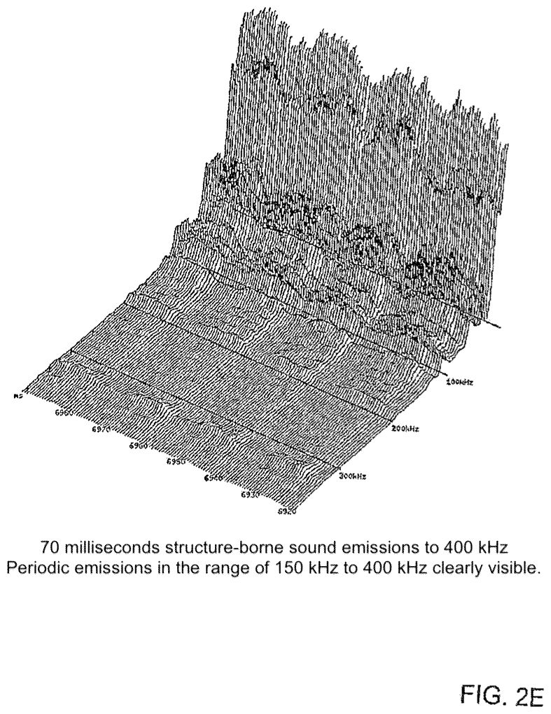

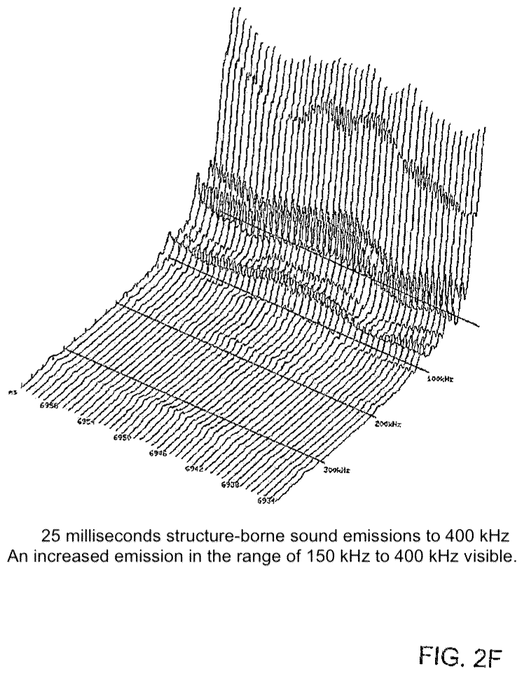

As illustrated in FIG. 2, the evaluation can be carried out in three dimensions with the coordinates of time, frequency and amplitude (or maximum amplitude or intensity or similar).

FIG. 2A shows the vibration spectrum of an almost complete pipe drawing process. A broadband, i.e. extending over almost the entire recorded frequency range, high-intensity chattering signal portion with a limited time duration can be recognised, starting from around second 7.

The chattering is signaled by broadband rising and falling emissions a few 100 ms in advance, see FIG. 2B. Successive emission lines show an increasing intensity. They can be recognised by pattern recognition and differ clearly from the emissions in normal, chatter-free operation, see FIG. 2C.

FIG. 2D is a detail of FIG. 2A immediately before the start of chattering with periodic oscillations. Individual vibration patterns are shown in FIG. 2E. A vibration is shown in FIG. 2F.

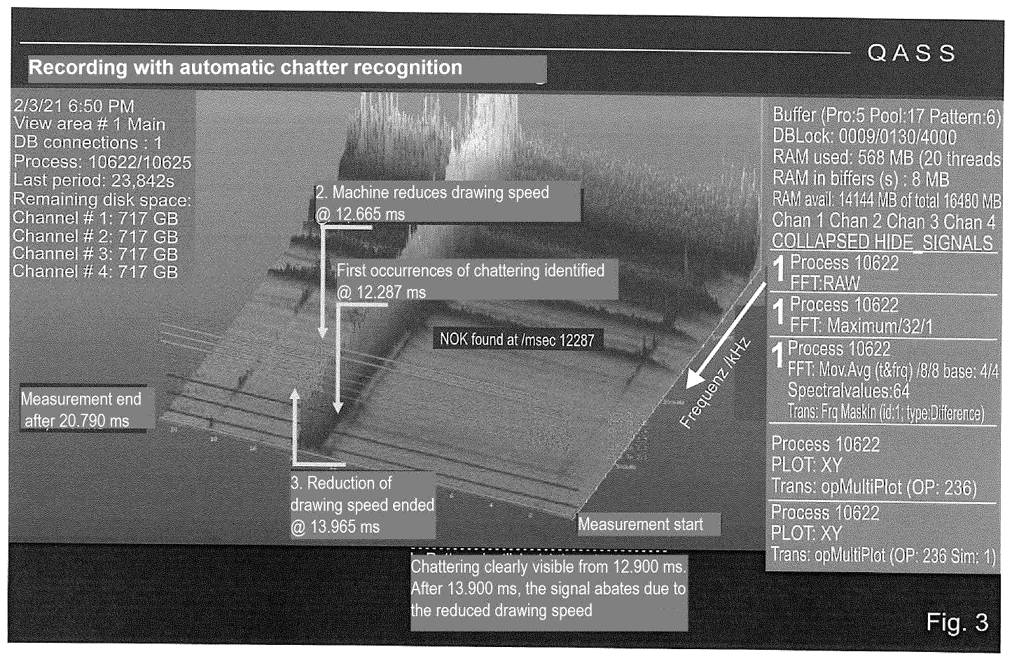

If the drawing speed is reduced in response to the detection of such rising and falling emissions, the emission lines disappear and chattering can be avoided; see FIG. 3.

If no broadband rising and falling emission is detected over a longer period of time, the drawing speed can be increased in accordance with the invention within the framework of any further operating parameters until such emission lines become apparent.

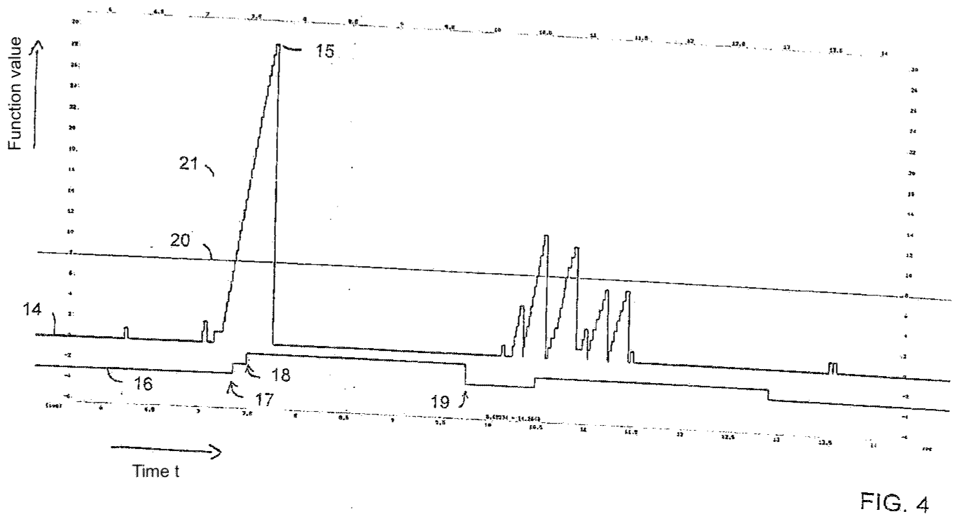

A possible control loop can be based on accumulated chatter pulses; see FIG. 4.

The upper curve 14 of FIG. 4 starts at (0.0) and reaches a function value of 29 at reference numeral 15. It describes cumulative chatter pulses in the frequency range of 200 kHz to 400 kHz, which is used here as an example. Each detection of a chatter pulse increases the value by 1.

A gradient analysis of the signal emission in this frequency range is performed in the time direction. Thus, the cumulative value is reset if, after the initial occurrence of periodic emissions signaling chattering, these periodic emissions cease for a predetermined period of time; the cumulative value is reset to 0 or by a reset value, e.g. −5.

If certain threshold values are exceeded, signals can be sent to the machine, e.g. to adjust the speed, in particular to reduce it. If the emissions signaling chattering then disappear, the cumulative value can be reduced or reset as described above and the machine can accelerate.

This is illustrated by the lower curve 16 of FIG. 4 with an exemplary three-stage speed control, which in other embodiments can also be four, five or more than five-stage or (quasi-) continuous. The value −3 here denotes the normal speed, the value −2, to which the speed is controlled at reference numeral 17, denotes a speed reduction of 25%, the value −1, to which the speed is controlled at reference numeral 18, denotes a speed reduction of −50%. At reference number 19, the speed can be controlled back to the normal value, as no chattering has been detected for a predetermined period of time. The threshold values associated with the reduction by 25% and 50%, respectively, at reference numerals 17 and 18 (and subsequent control points) are illustrated by the horizontal lines 20 and 21; the reduction can take place in more than 2 stages and/or (quasi-) continuously.

The invention thus creates an adaptive control of the drawing speed, which remains close to the maximum even when the operating parameters (tool wear, lubricant variation, temperature change, etc.) change.

1. A method for producing tubes, wires, profiles and similar long material by means of a drawing device, in which method vibration emissions are detected and analysed during the drawing process on a material strand and/or on a drawing device in order to detect defects such as drawing grooves and chatter marks, characterised in that the vibration emissions are continuously subjected to a spectral analysis in such a way that the occurrence or absence of emissions which rise and fall over time and/or pulse-like emissions is recognised, and that the drawing speed is changed in response thereto.

2. The method according to claim 1, characterised in that the drawing speed is reduced if the occurrence of emissions is detected.

3. The method according to claim 1, characterised in that the drawing speed is increased if the absence of emissions is detected.

4. The method according to claim 1, characterised in that the drawing speed is adaptively controlled.

5. The method according to claim 1, characterised in that the vibration emissions are divided into frequency ranges of low and high emission and the detection is performed in the low emission range.

6. A drawing device for drawing tubes, wires, profiles and similar material strands, with a sensor for detecting vibrations which occur on the material strand and/or on the drawing device during the drawing process, and an evaluation device coupled to the sensor for evaluating the detected vibrations for the purpose of recognising defects such as drawing grooves and chatter marks, characterised in that the evaluation device is designed to continuously subject vibration emissions to a spectral analysis in such a way that the occurrence or absence over time of rising and falling emissions and/or pulse-like emissions is detected, and is designed for open-loop or closed-loop control of the drawing speed in response to the detection.

7. The drawing device according to claim 6, characterised in that the sensor is coupled to an outer tool.

8. The drawing device according to claim 6, characterised in that the sensor is coupled to an inner tool.
